(19) United States
(12) Patent Application Publication
(10) Pub. No.: US 2009/0153007 A1
(43) Pub. Date: Jun. 18, 2009

(54) LIGHT SOURCE MODULE AND METHOD FOR MANUFACTURING SAME

(75) Inventor: WEN-JANG JIANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/212,986

(22) Filed: Sep. 18, 2008

(30) Foreign Application Priority Data
Dec. 17, 2007 (CN) 200710203150.2

(51) Int. Cl. H01J 7/24; H01J 9/00

(52) U.S. Cl. 313/11; 445/23

(57) ABSTRACT

A light source module includes a light source and an thermoelectric cooler. The thermoelectric cooler includes a first base board, a second base board and a number of thermoelectric cooling units. The first base board includes a first surface and an opposing second surface. The second base board includes a top surface and a bottom surface. The light source is defined on the first surface of the first base board. The thermoelectric cooling units are disposed between the first surface of the first base board and the top surface of the second base board, and are configured for transferring heat generated from the light source from the first base board to the second base board.

### CROSS-REFERENCE TO RELATED APPLICATION

This application is related to the following commonly-assigned copending applications: Ser. No. 12/206,171, entitled “ILLUMINATION DEVICE” (attorney docket number US 18668). Disclosures of the above-identified application are incorporated herein by reference.

### BACKGROUND

1. Field of the Invention

The present invention relates to light source modules and, particularly, to a light source module having high heat-dissipation efficiency, and a manufacturing method for the same.

2. Description of Related Art

Light emitting diodes (LEDs) are widely used in light source modules due to high brightness, long lifespan, wide color gamut and so on. LEDs generally emit visible light at specific wavelengths and generate a significant amount of heat. Generally, approximately 80-90% of the electric energy consumed by the LEDs is converted to heat, with the remainder of the electric energy converted to light. If the generated heat cannot be timely dissipated, the LEDs may overheat, and thus the performance and lifespan may be significantly reduced.

Therefore, heat-dissipating apparatuses are applied in the light source modules to quickly take away the heat generated by the LEDs. The heat-dissipating apparatus includes a fan to induce an airflow for the purpose of cooling the LEDs and a number of fins. However, during the working process of the heat-dissipating apparatus, dust and other particles in the air may negatively impact the working efficiency and lifespan of the fins of the heat-dissipating apparatus, thereby shortening the lifespan of the light source modules.

What is needed, therefore, is a light source module with high heat-dissipation efficiency and a method for manufacturing the same which can overcome the above-described problems.

### SUMMARY

An exemplary embodiment of a light source module includes a light source and a thermoelectric cooler. The thermoelectric cooler includes a first base board, a second base board and a number of thermoelectric cooling units. The first base board includes a first surface and an opposing second surface. The second base board includes a top surface and a bottom surface. The light source is defined on the first surface of the first base board. The thermoelectric cooling units are disposed between the first surface of the first base board and the top surface of the second base board, and are configured for transferring heat generated by the light source from the first base board to the second base board.

Advantages and novel features will become more apparent from the following detailed description when taken in conjunction with the accompanying drawings.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a cross-sectional view of a light source module according to an exemplary embodiment.

FIG. 2 to FIG. 7 are views showing each step of a method for manufacturing the light source module of FIG. 1.

### DETAILED DESCRIPTION

An embodiment will now be described in detail below and with reference to the drawings.

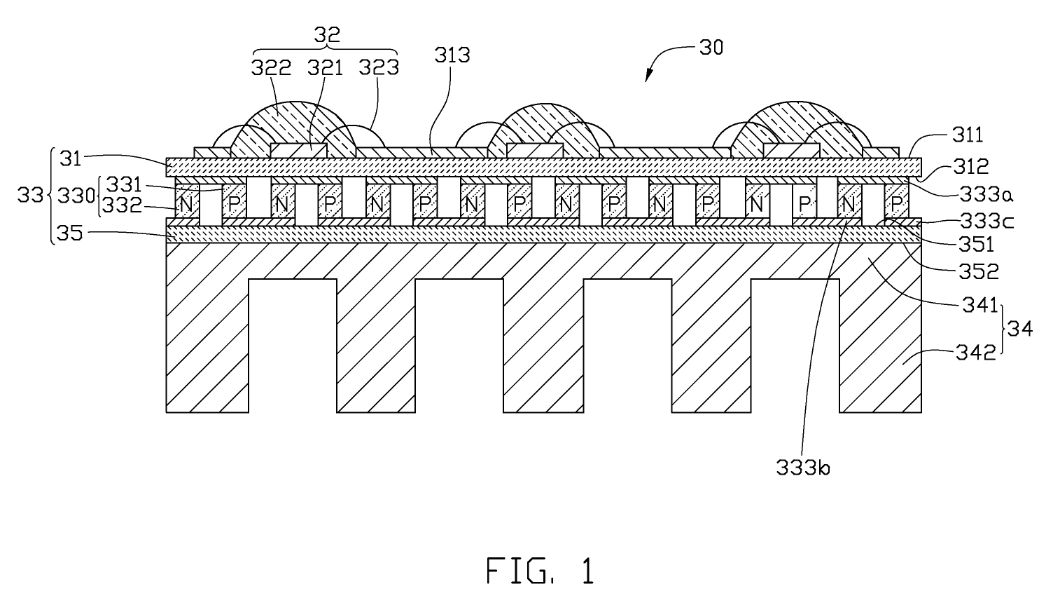

Referring to FIG. 1, an exemplary embodiment of a light source module 30 includes a light source 32, a thermoelectric cooler 33, and a heat-dissipating apparatus 34.

The light source 32 is an LED light source, and includes an LED chip 321, a package 322, and electrical wire 323. The package 322 encapsulates the LED chip 321. The electrical wire 323 is configured for electrically connecting the LED chip 321 to other electrical components.

The thermoelectric cooler 33 includes a first base board 31, a second base board 35, a number of thermoelectric cooling units 330 disposed between the first and second base boards 31, 35. Each of the thermoelectric cooling units 330 includes a P-type semiconductor 331, an N-type semiconductor 332, a first electrically conductive pad 333a, a second electrically conductive pad 333b, and a third electrically conductive pad 333c. The first electrically conductive pad 333a is configured for electrically connecting the P-type semiconductor 331 to the N-type semiconductor 332. The second electrically conductive pad 333b and the third electrically conductive pad 333c are configured for electrically connecting the N-type semiconductor 332 and the P-type semiconductor 331 to two electrodes of a direct current electrical source, respectively. Each of the P-type semiconductors 331 and the N-type semiconductors 332 is a solid state block made of a compound semiconductor selected from the group consisting of Bi—Te based semiconductors, Sb—Te based semiconductors, Bi—Se based semiconductors, Pb—Te based semiconductors, Ag—Sb—Te based semiconductors, Si—Ge based semiconductors, Fe—Si based semiconductors, Mn—Si based semiconductors and Cr—Si based semiconductors. In the present embodiment, each of the P-type semiconductors 331 and the N-type semiconductors 332 is a Bi₂Te₃ based semiconductor.

The thermoelectric cooling units 330 are arranged between the first base board 31 and the second base board 35 in an array. In this embodiment, spaces between adjacent thermoelectric cooling units 330 are identical. In this embodiment, all of the thermoelectric cooling units 330 are electrically connected in series, and are electrically connected to a direct current electrical source. In other embodiments, some thermoelectric cooling units 330 may be connected in series, and the remaining thermoelectric cooling units 330 connected in parallel.

The first and second base boards 31, 35 are electrically insulating and have excellent thermal conductive performance. The first and second base boards 31, 35 can be made of ceramic, silicon, or anodic aluminum oxide (AAO) material. The first base board 31 includes a first surface 311 and a second surface 312 on a side opposite to the first surface 311. The LED chip 321 is disposed on the first surface 311, and the thermoelectric cooling units 330 are disposed on the second surface 312. A circuit 313 is defined on the first surface 311, and is electrically connected to the LED chip 321 through the electrical wire 323.

The first electrically conductive pads 333a are disposed on the second surface 312 of the first base board 31 such that each of the thermoelectric cooling units 330 thermally connects with the second surface 312. The second and third electrically conductive pads 333b, 333c are disposed on a top surface 351 of the second base board 35 such that each of the thermoelectric cooling units 330 thermally connect to the second base board 35. The first, second, third electrically conductive pads 333a, 333b, 333c are comprised of materials having excellent thermal conductive performance and good electrical conductive performance, e.g., copper.

The heat-dissipating apparatus 34 is thermally connected to the second base board 35. The heat-dissipating apparatus 34 includes a heat-dissipating base 341 and a number of fins 342 formed on the heat-dissipating base 341. The heat-dissipating base 341 is formed on a bottom surface 352 of the second base board 35.

Compared with conventional light source modules, the light source module 30 has the following advantages. Firstly, the circuit 313 is formed on the first surface 311 of the first base board 31 of the thermoelectric cooler 33. Under these circumstances, the first base board 31 functions as a printed circuit board. The first base board 31 of the thermoelectric cooler 33 is made of thermally conductive material, and has excellent thermal conductive performance relative to printed circuit board made of standard materials. Therefore, the light source module 30 has high heat-dissipating performance. Secondly, because there are a number of thermoelectric cooling units 330 between the first base board 31 and the second base board 35, the heat generated from the LED chip 321 can be quickly taken away by the thermoelectric cooling units 330.

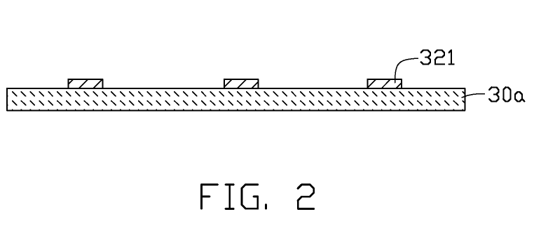

Referring to FIG. 2 to FIG. 7, a method for manufacturing the above-described light source module 30 is recited below.

In a general first step, referring to FIG. 2, a number of LED chips 321 is grown on a medium 30a. Usefully, the medium 30a is made of sapphire, silicon carbide, III-V group compound based semiconductor, or II-VI group compound based semiconductor. Specifically, the LED chips 321 are formed on the medium 30a by an epitaxial growth method. The LED chips 321 formed on the medium 30a are un-encapsulated semiconductors.

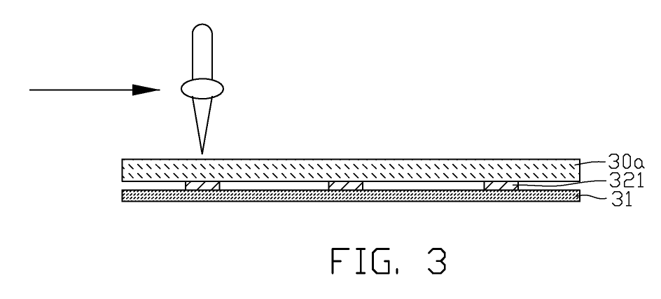

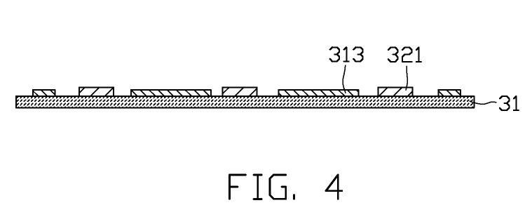

In a general second step, referring to FIG. 3, the first base board 31 is applied to the LED chips 321 by use of thermally conductive grease or an eutectic metal applied between the LED chips 321 and the first surface 311 of the first base board 31 so as to paste and fix the LED chips 321 on the first surface 311 of the first base board 31. Then, the medium 30a is removed from the LED chips 321, leaving the LED chips 321 attached on the first surface 311 of the first base board 31, as shown in FIG. 4. The medium 30a can be removed from the LED chips 321 using laser ablation, etching, or polishing, or a combination thereof. In the present embodiment, the medium 30a is removed from the LED chips 321 using the laser ablation process.

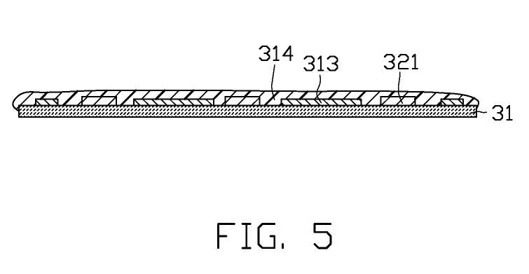

In a general third step, referring to FIG. 4, the circuit 313 is formed on the first surface 311 of the first base board 31. The circuit 313 can be formed on the first surface 311 using a vapor deposition method such as sputtering, or a liquid deposition method such as electroless plating. In the present embodiment, the circuit 313 is sputtered on the first surface 311. In detail, a mask having a predetermined pattern is applied on the first surface 311, thus, the circuit 313 with a desired pattern corresponding to the predetermined pattern of the mask is achieved. In addition, referring to FIG. 5, a protective layer 314 is formed on the first surface 311 to encapsulate the LED chips 321 and the circuit 313. As a result, the LED chips 321 and the circuit 313 are isolated from outside (e.g., atmosphere or other pollutant). In the present embodiment, the protective layer 314 is a black wax.

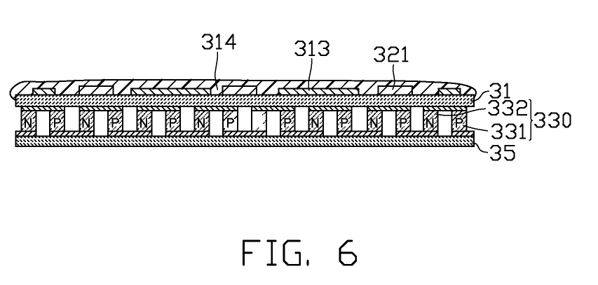

In a general fourth step, referring to FIG. 6, a number of the thermoelectric cooling units 330 are mounted between the second surface 312 and the second base board 35. A number of the first electrically conductive pads 333a are fixed on the second surface 312 and electrically connect the P-type semiconductors 331 to the adjacent N-type semiconductors 332. The second electrically conductive pads 333b and the third electrically conductive pads 333c are fixed on the top surface 351 of the second base board 35 to electrically connect the P-type semiconductors 331 and the N-type semiconductors 332 to two electrodes of a direct current electrical source, respectively.

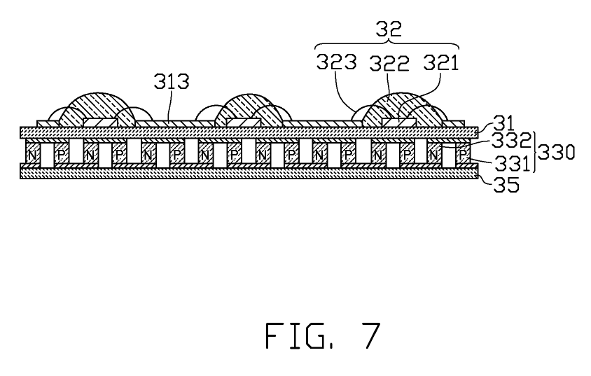

In a general fifth step, referring to FIG. 7, each of the LED chips 321 is packaged by a package 322. The protective layer 314 is removed from the first surface 311 prior to packaging the LED chips 321. The packaging process includes several sub-processes, e.g., wiring-bonding and encapsulating. In the wiring-bonding process, a number of electrical wires 323 are applied to electrically connect the LED chips 321 to the circuit 313. In detail, an end of each of the electrical wire 323 is electrically connected with each of LED chips 321, and another end of the electrical wire 323 is electrically connected with the circuit 313. After the wiring-bonding process is finished, the packages 322 is applied to the first surface 311 of the first base board 31 to encapsulate the LED chips 321 therein.

In a general fifth step, a heat-dissipating apparatus 34 is thermally coupled to the thermoelectric cooling units 330. Specifically, the heat-dissipating base 341 of the heat-dissipating apparatus 34 is fixed to the bottom surface 352 of the second base board 35.

During a working process of the light source module 30, the direct current electrical source is provided between the second electrically conductive pad 333b and the third electrically conductive pad 333c. Fox example, the second electrically conductive pad 333b is electrically connected to an anode, and the third electrically conductive pad 333c is electrically connected to a cathode. Therefore, electrons in the N-type semiconductors 332 and cavities in the P-type semiconductors 331 move from the first base board 31 to the second base board 35, thus, the heat generated by the light source 32 is carried by the electrons and cavities to move from the first base board 31 to the second base board 35. As a result, the heat generated by the light source 32 is quickly taken away by the thermoelectric cooler 33. In addition, the heat-dissipating apparatus 34 dissipates the heat of the second base board 35 timely, thereby the light source module 30 is cooled effectively.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light source module comprising:
at least a light source; and
a thermoelectric cooler comprising a first base board, a second base board and a plurality of thermoelectric cooling units, the first base board comprising a first surface and an opposing second surface, the second base board comprising a top surface and a bottom surface;
wherein the light source is mounted on the first surface of the first base board, the thermoelectric cooling units are disposed between the first surface of the first base board and the top surface of the second base board, and configured for transferring heat generated by the light source from the first base board to the second base board.

2. The light source module as claimed in claim 1, wherein each of the thermoelectric cooling units includes a P-type semiconductor, an N-type semiconductor, a first electrically conductive pad, a second electrically conductive pad and a third electrically conductive pad, the first electrically conductive pad is configured for electrically connecting the P-type semiconductor to the N-type semiconductor, the second electrically conductive pad and the third electrically conductive pad are configured for electrically connecting the P-type semiconductor and the N-type semiconductor to a direct current power source.

3. The light source module as claimed in claim 2, wherein the first electrically conductive pad is fixed on the second surface of the first base board, the second electrically conductive pad and the third electrically conductive pad are fixed on the top surface of the second base board.

4. The light source module as claimed in claim 1, wherein the thermoelectric cooling units are arranged between the first base board and the second base board in an array.

5. The light source module as claimed in claim 1, wherein the thermoelectric cooling units are electrically connected in series.

6. The light source module as claimed in claim 1, further comprising a heat dissipating apparatus thermally connected to the bottom surface of the second base board.

7. The light source module as claimed in claim 6, wherein the heat dissipating apparatus comprises a heat-dissipating base and a plurality of fins formed on the heat-dissipating base, a surface of the heat-dissipating base is attached on the bottom surface of the second base board.

8. The light source module as claimed in claim 2, wherein each of the P-type semiconductors and the N-type semiconductors is a solid state block.

9. The light source module as claimed in claim 2, wherein each of the P-type semiconductors and the N-type semiconductors is made of a compound semiconductor selected from the group consisting of Bi—Te based semiconductors, Sb—Te based semiconductors, Bi—Se based semiconductors, Pb—Te based semiconductors, Ag—Sb—Te based semiconductors, Si—Ge based semiconductors, Fe—Si based semiconductors, Mn—Si based semiconductors and Cr—Si based semiconductors.

10. The light source module as claimed in claim 1, wherein the light source comprises a light emitting diode, an electrical wire and a package encapsulating the light emitting diode.

11. The light source module as claimed in claim 10, wherein a circuit is formed on the first surface of the first base board, the light emitting diode is electrically connected to the circuit via the electrical wire.

12. The light source module as claimed in claim 1, wherein each of the first base board and the second base board are comprised of ceramic material.

13. The light source module as claimed in claim 1, wherein each of the first base board and the second base board is comprised of silicon or anodic aluminum oxide material.

14. A light source module comprising:
an thermoelectric cooler comprising a circuit board, a cooling board and a plurality of thermoelectric cooling units disposed between the circuit board and the cooling board; and
a plurality of light emitting diodes mounted on an opposite side of the circuit board to the thermoelectric cooling units.

15. The light source module as claimed in claim 14, wherein each of the circuit board and the cooling board is comprised of ceramic material.

16. The light source module as claimed in claim 14, wherein each of the circuit board and the cooling board is comprised of silicon or anodic aluminum oxide material.

17. The light source module as claimed in claim 14, wherein a heat dissipating apparatus is thermally connected to an opposite side of the cooling board to the thermoelectric cooling units.

18. The light source module as claimed in claim 14, wherein each of the thermoelectric cooling units includes a P-type semiconductor, an N-type semiconductor, a first electrically conductive pad, a second electrically conductive pad and a third electrically conductive pad, the first electrically conductive pad is formed on the circuit board and is configured for electrically connecting the P-type semiconductor to the N-type semiconductor, the second electrically conductive pad and the third electrically conductive pad are formed on the cooling board and are configured for electrically connecting the P-type semiconductor and the N-type semiconductor to a direct current power source.

19. A method for manufacturing a light source module comprising:
forming a light emitting diode on a surface of a medium;
providing a first base board comprising a first surface and an opposing second surface, and a second base board comprising a top surface and a bottom surface;
attaching the first base board to the light emitting diode on the medium such that the light emitting diode is fixed on the first surface of the first base board;
removing the medium from the light emitting diode;
forming a circuit on the first surface of the first base board;
disposing a plurality of thermoelectric cooling units between the second surface of the first base board and the top surface of the second base board; and
packaging the light emitting diode.

20. The method as claimed in claim 19, wherein the first base board is attached to the light emitting diode on the medium by means of applying a thermally conductive grease or an eutectic metal between the light emitting diode and the first surface of the first base board to fix the light emitting diode on the first surface.
